(19) United States
(12) Patent Application Publication
(10) Pub. No.: US 2013/0164079 A1
(43) Pub. Date: Jun. 27, 2013

(54) LATCHING ASSEMBLY FOR LIVESTOCK STANCHION AND METHODS OF USE

(71) Applicant: Michael Edwards, Tulare, CA (US)

(72) Inventor: Michael Edwards, Tulare, CA (US)

(21) Appl. No.: 13/336,502

(22) Filed: Dec. 23, 2011

(51) Int. Cl. A01K 15/04; B23P 11/00; F16B 17/00

(52) U.S. Cl. 403/327; 403/345; 29/428

(57) ABSTRACT

The present invention provides improved latching assemblies for use in animal stanchions that are easy to remove and replace, that are better able to withstand pressures exerted by animals in the stanchions, and methods of removal and replacement that do not require removal of the support pipe nor removal of any other stanchion latches along the support pipe between the removed latch and the end of the pipe. Embodiments of the improved latching assemblies of the present invention include one or both of the features of (a) a removable lower portion, and (b) a reinforced pivotal section.

### BACKGROUND OF THE INVENTION

1. Field of the Invention

The present invention relates to latching assemblies, and more particularly to an improved latching assembly for use with livestock stanchions and related methods of installation, removal, use and repair.

2. Description of the Related Art

Livestock stanchions have been used for years to restrain the heads of animals such as cattle, horses and goats for limited periods of time. Such temporary restraint ordinarily occurs in association with feeding the animal to prevent the animal from over feeding, and also allows the animal to be examined, groomed, cleaned, vaccinated, artificially inseminated or otherwise administered to without disruption. In dairies, stanchions are often employed to hold the cattle during the milking process. Animal stanchions may also be used to temporarily separate one or more head of cattle from the herd.

A typical stanchion includes a pivotable vertically oriented bar that is used to hold the head of the animal in place. The animal pushes its head through an opening in the stanchion bounded on one side by the pivotable bar. By moving the head down to feed from a trough, the bar pivots and latches at an upper location thereby restricting the size of the opening through which the head was inserted, and preventing the animal from removing its head. When it is time to release the animal, the vertical bar is unlatched at the top which enlarges the size of the opening thereby allowing the animal to remove its head.

An example of a typical stanchion latch is found in U.S. Pat. No. 5,975,027 which discloses a stanchion latch that may be opened by providing outward pressure on either of two pivotable latching members from an inner gap between the latching members. This pressure causes one or both of the latching members to rotate such that their lower end(s) move to release the upper end of the stanchion bar. Livestock stanchions are typically provided in groups or banks made up of a series of several individual stanchions.

Animals restrained in a stanchion will often try to escape. Large and strong animals such as horses and cattle may cause damage to the stanchion and its parts from these escape efforts. In particular, the edges and lower ends of the pivotal latching members may be bent, deformed or otherwise damaged from this activity. Over time, the lower ends of these latching members tend to wear out such that they can no longer accomplish a latching function, and must be replaced. In addition, the animal movement may damage the pivoting nut-bolt assemblies that hold the latches onto their horizontal mounting pipes, often making it difficult or impossible to unscrew the nut from the bolt in these assemblies to remove the latch.

Removing existing damaged or broken latches is difficult because such latches are engaged around a mounting support pipe. Thus, even after the nut-bolt pivot is removed (often with difficulty), the latch itself must either be cut off, or slid down the support pipe for removal. Even if the damaged latch is cut from the pipe, the replacement latch must be slid down the pipe back into place since it must extend around the pipe. Sliding latches up and down the pipe usually requires removal of the pipe from the stanchion, as well as removal of any other latches along the pipe between the damaged latch and the closest pipe end. Since stanchions are usually provided in banks of 6 or 8, several other latches may need to be removed from the pipe (often with difficulty) to get to the damaged one. This is a time consuming and cumbersome process which shuts down all of the stanchions in the bank until it is completed.

It is therefore desirable to provide latching mechanisms for livestock stanchions that are easy to remove and replace. It is also desirable to provide methods for removing and replacing damaged livestock stanchion latches that do not require removal of the support pipe or removal intermediate latches.

### SUMMARY OF THE INVENTION

The present invention addresses these desires by providing improved latching assemblies for use in animal stanchions that are easy to remove and replace, and by providing methods of removal and replacement that do not require removal of the support pipe and/or that do not require removal of any other stanchion latches.

Embodiments of the present invention include an improved latch assembly having one or two important features. The first feature is a removable lower portion of the latch assembly that is deployed below the horizontal mounting pipe. This removable portion allows embodiments of the latch to be easily removed from the horizontal stanchion support pipe without requiring removal of the pipe itself, nor removal of all latches between the removed latch and the end of the support pipe. In particular, it is not necessary to slide these embodiments of the latch down the support pipe in order to remove them. These embodiments of the latch have a lower portion that is provided with two opposite sides or legs defining a central open area. A removable portion spans this open area at one end (usually the bottom) between the legs, such that it is located below the horizontal support pipe when the latch is installed. In preferred embodiments, the removable portion may be provided in the form of a coupler nut provided between opposite sides of the latch itself. Embodiments of a coupler nut are provided in the form of an elongated generally tubular member having openings at either end. In embodiments of the latch, two openings are provided, one on each of the two opposite sides (legs) of the latch body. In these embodiments, a bolt is inserted through each of these two openings, one on each side, and into the openings in the coupler nut to hold it in place. In different embodiments, the removable portion may be provided in other forms of coupling devices, including without limitation a pin with retainer clips, a cylindrical body with spring-loaded pins on opposite ends, and the like. The removable portion (e.g., coupler nut, pin with clips, etc.) should be made of sturdy material so that it can withstand the considerable stress imparted by livestock trying to get free from the stanchion.

To install embodiments of the invention, the removable portion of the latch is removed (e.g., the bolts are unscrewed from the ends of the coupler nut), and the two sides or legs of the lower portion of the latch body are placed over the horizontal support pipe in a straddling position. The removable portion is then attached to and between the two legs of the latch body underneath the support pipe (e.g., the bolts are inserted through the holes in the legs and screwed into the ends of the coupler nut). The pivotal section of the latch is then attached to the pipe. To remove such embodiments of the invention, the pivotal section of the latch is first detached from the pipe; then, the removable portion is detached from between the two legs of the latch body and removed, allowing the latch to then be removed from the pipe.

The second feature, which may be provided with or provided independently from the first feature, is a special pivoting mechanism for pivotal attachment of the latch to the horizontal mounting pipe. As noted in the background discussion above, in existing latches, the bolt used to mount the latch to the horizontal pipe extends through the pipe, and may become stripped or damaged from the stress imparted by livestock trying to escape from the stanchion. In embodiments of the present invention, a sleeve is inserted into the openings in the horizontal pipe that receives the bolt before it is inserted. In some embodiments, these openings may be reduced, enlarged or otherwise sized in order to receive the sleeve. The sleeve may be provided in any suitable form, such as without limitation, a spring pin (which may be self-expanding), a pipe, tubing, a press fit bushing, a bushing with a head (two-piece set), and the like. The sleeve provides a protective cover for the bolt, preventing it from being stripped or damaged by friction against the openings in the sides of the support pipe while inserted therein as an animal thrashes in the stanchion trying to escape.

It is therefore an object of the present invention to provide latching mechanisms for livestock stanchions that are easy to install and remove.

It is another object of the present invention to provide methods for easily installing and removing latches for livestock stanchions.

Additional objects of the invention will be apparent from the detailed descriptions and the claims herein.

### BRIEF DESCRIPTION OF THE DRAWINGS

FIG. 1 is a side view of a bank of prior art livestock stanchions.

FIG. 2 is a perspective view of embodiments of a latch of the present invention installed on a support pipe.

FIG. 3 is a rear perspective view of an embodiment of a latch of the present invention.

FIG. 4 is a front perspective view of an embodiment of a latch of the present invention.

FIG. 5 is a perspective exploded view of an embodiment of a latch of the present invention.

FIG. 6 is a perspective view of alternative embodiments of a latch of the present invention installed on a support pipe.

FIG. 7 is a rear perspective view of an alternative embodiment of a latch of the present invention.

FIG. 8 is a front perspective view of an alternative embodiment of a latch of the present invention.

FIG. 9 is a perspective exploded view of an alternative embodiment of a latch of the present invention.

### DETAILED DESCRIPTION

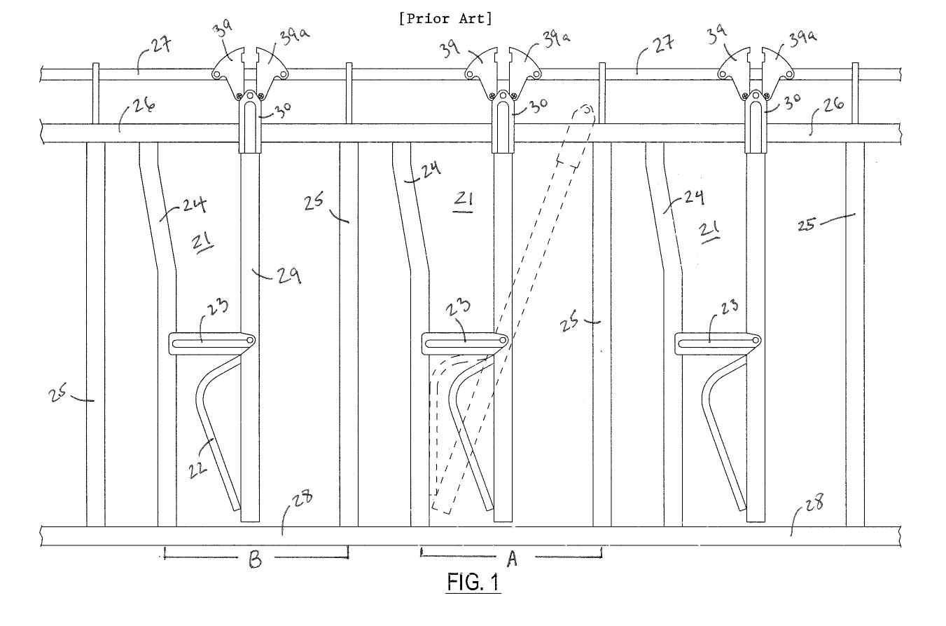

Referring to the drawings wherein like reference characters designate like or corresponding parts throughout the several views, and referring particularly to the bank of prior art stanchions shown in FIG. 1, it is seen that each stanchion generally includes a frame having a plurality of stanchion openings 21. Each frame has two substantially vertical extending side frame members 24 and 25, such that the bank comprises a plurality of first substantially vertical extending side frame members 24 and second substantially vertical extending side frame members 25. Each frame also comprises a substantially horizontally extending first (upper) frame member 26, a substantially horizontally extending second (upper) frame member 27, and a substantially horizontally extending third (lower) frame member 28. Side frame member 24 couples with first horizontal frame member 26; and side frame member 25 couples to second horizontal frame member 27.

The stanchion also includes restraining members or bars 29, each bar 29 being pivotally mounted to a lateral arm 23 mounted to a side frame member 25. As shown in FIG. 1, each restraining member 29 may be pivoted between a first position extending diagonally across the stanchion opening 21 as shown in phantom lines at configuration “A”, and a second, substantially vertical position as in the stanchion opening as shown in configuration “B”. When the restraining member 29 is in the position corresponding to A, an animal may insert its head into the area of the stanchion opening 21 above restraining member 29. When the animal lowers its head, the restraining member 29 is pivoted to the vertical position as shown in configuration B. Since the area between the vertically oriented restraining member 29 and side frame member 24 is narrower than the animal's head, locking the restraining member 29 in the vertical position will restrain the animal in the stanchion. When unlatched, the restraining member 29 may be pivoted by the animal to the diagonally-extending position of stanchion A so that the animal may remove its head.

The upper end of the restraining member 29 ordinarily includes a retaining ring 30 which is mounted to first frame member 26. The retaining ring 30 slides along the first frame member 26 as the restraining member 29 pivots at a distal end of lateral arm 23. Retaining ring 30 is shaped to extend above the first frame member 26 so that the ring 30 may be engaged by a latching assembly comprising a plurality of latches 39 and 39a mounted in pairs upon second frame member 27, to secure the restraining member 29 in the vertically oriented position B. Restraining member 29 also preferably includes an angular arm 22 which prevents the insertion of an animal head into the area below the lateral arm 23 and the restraining member 29. The prior art latches 39 are ordinarily provided on the upper frame member 27, with a pair of latches oppositely positioned latches 39, 39a being provided for each pivotable restraining member 29. When engaged, the restraining member 29 will be held in place by latches 39, 39a in a substantially vertical position as shown by B of FIG. 1, whereby an animal will be restrained from removing its head from stanchion opening 21. When disengaged, the restraining member 29 will not engage latches 39, 39a and an animal will be free to remove its head from the stanchion.

Prior art latches 39 have a large central opening that is designed to be engaged around upper frame member 27. It is only possible to attach such latches to frame member 27 by sliding them down member 27 to a desired location. They are then pivotally attached to frame member using a nut and bolt. It is only possible to remove these prior art latches 39 from frame member 27 by either (a) cutting or breaking them off, or (b) sliding them down to the end of frame member 27, which requires removal of all intermediate latches on frame member 27.

The second upper frame member 27 is ordinarily provided in the form of a pipe or cylindrical bar that may be rotated in place, so that rotating member 27 will cause all of the latches 39 mounted thereon to be disengaged from their respective restraining members 29, releasing all stanchion frames and any animals having their heads inserted therein.

As described above, once an animal has inserted its head into an opening 21 and a restraining member 29 has pivoted into place as shown in B, the upper end of restraining member 29 (or ring 30) is held in place by latches 39. Thereafter, any thrashing or other motion by the animal in attempting to escape from the stanchion is transmitted along member 29 to the latches 39. This activity wears down and deforms the latches 39, particularly the bottom sections thereof which bear directly against restraining members 29 or rings 30. Eventually latches 39 become so worn or deformed that they are no longer capable of effectively holding restraining members 29 in place, and must be replaced. As described above, removing prior art latches 39 requires either cutting them off, or sliding them along frame member 27, which requires removing all latches 39 between the damaged latch and the end of member 27.

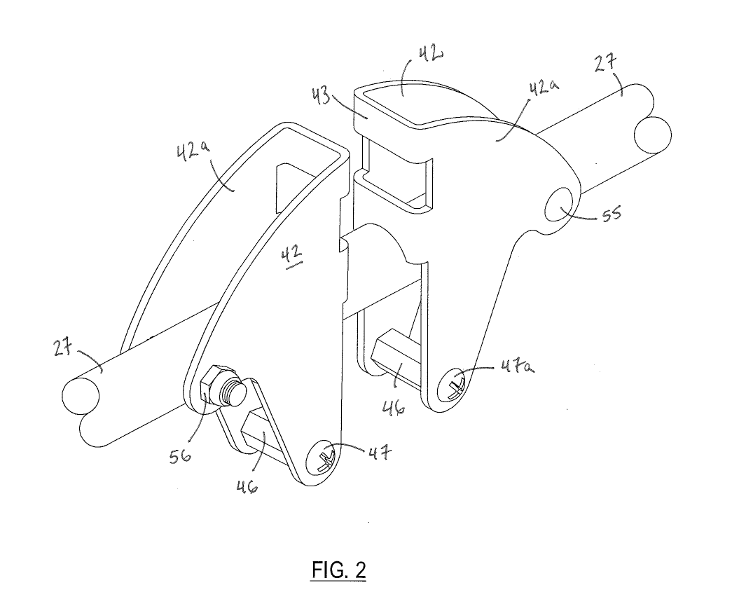

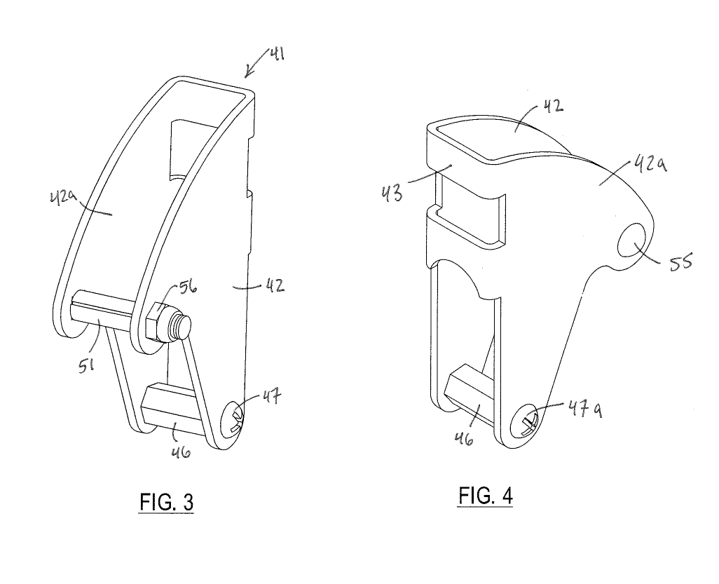

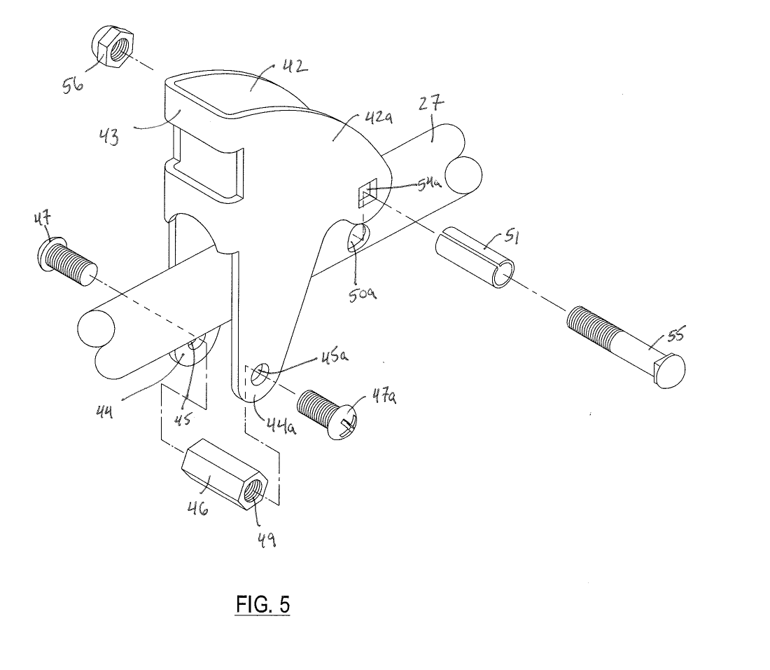

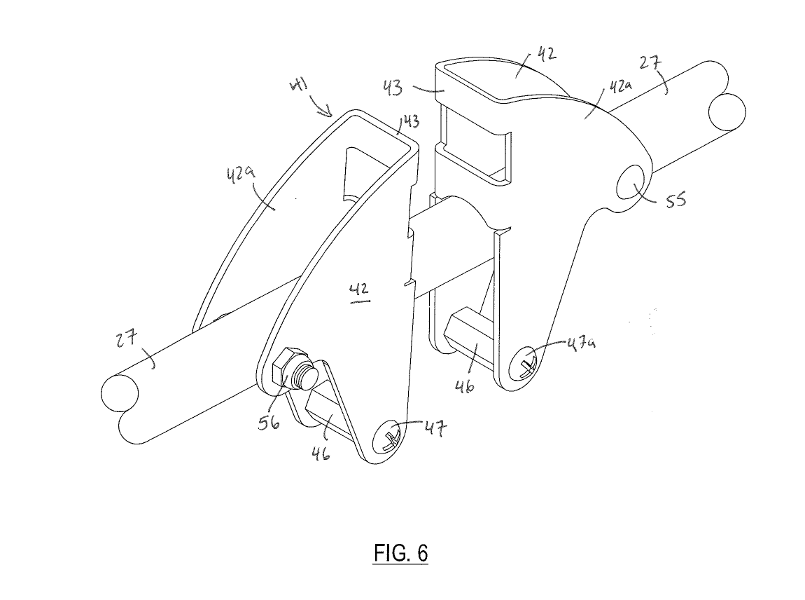

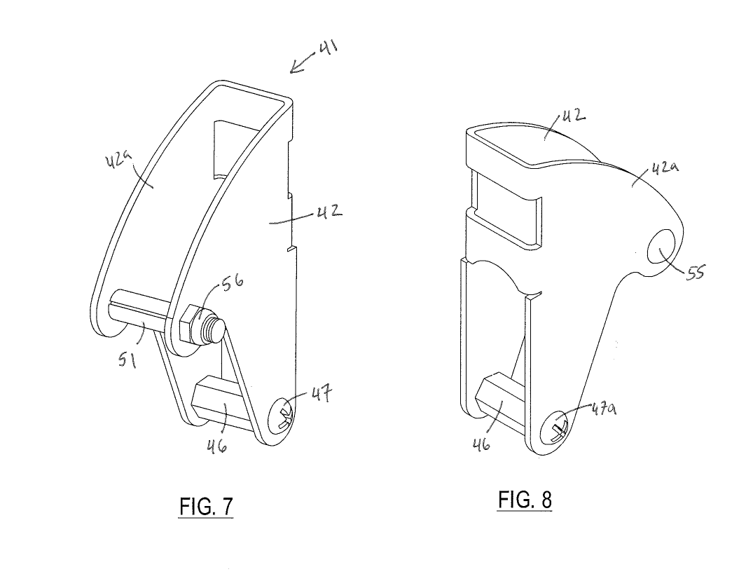

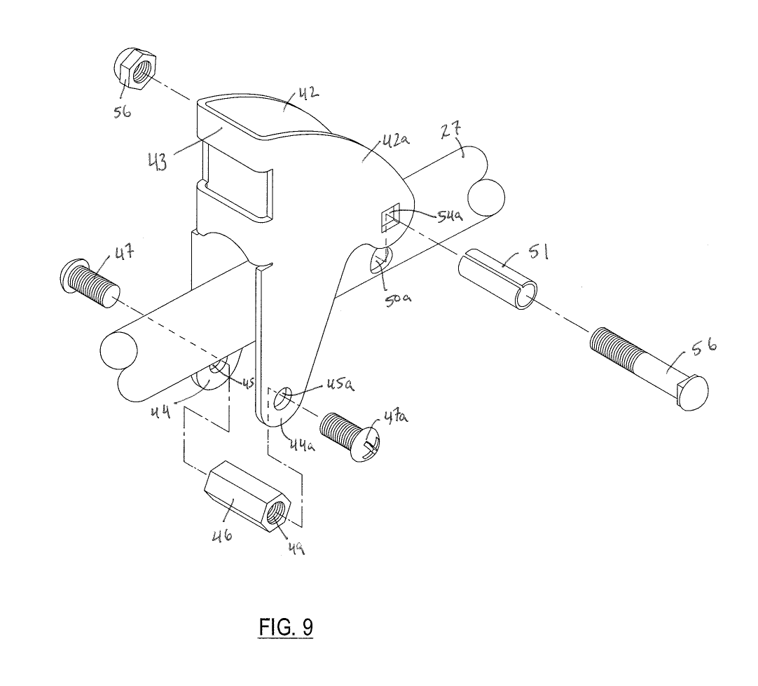

Referring to FIGS. 2-5, it is seen that the illustrated embodiment of the present invention includes a latch assembly 41 for use on a livestock stanchion that includes a body made up of two sides or legs 42, 42a that are connected at an upper section by at least one upper cross member 43. Legs 42, 42a are preferably flattened and generally parallel to each other. Additional cross pieces may be provided, and may be shaped to conform to the curvature of pipe member 27 as shown. Each leg 42, 42a of latch 41 includes a slightly enlarged lower section that provides room for both an opening 45, 45a together with sufficient reinforcement or material at 44, 44a to withstand the pressures that will be exerted on the latch during use. See FIG. 5. The openings 45, 45a are preferably but not necessarily provided directly across from each other on sides 42, 42a of latch 41. A removable cross piece 46 is provided that fits between sides 42, 42a at or near openings 45, 45a. In a preferred embodiment, cross piece 46 is provided in the form of a coupler nut having at least one helical bore 49, as shown in FIG. 5. Such a coupler nut is placed between openings 45 and 45a, such that bolts 47, 47a may be inserted through openings 45, 45a into opposite ends of the bore(s) 49 of the coupler nut to secure the coupler nut to the sides 42, 42a of latch 41. An assembled embodiment of a latch of the present invention is illustrated in FIGS. 3 and 4. Removal of bolts 47, 47a in the illustrated embodiment allows cross piece 46 to be removed, opening up the central area of latch 41. When cross piece 46 is removed, this configuration makes it possible to engage legs 42, 42a of latch 41 by straddling them over cylindrical pipe 27, or to remove latch 41 from pipe 27, as shown in FIG. 5. It is to be appreciated that other rigid pieces may be used as cross members 46 including without limitation, dual bore coupler nuts, other nut and bolt assemblies, rod and cotter pin assemblies, a pin with retainer clips, spring-loaded pin assemblies, and the like.

Another feature found in embodiments of the present invention is an improved and reinforced pivoting section for that portion latch 41 that engages with pipe 27. In preferred embodiments of the present invention, a sleeve 51 is provided for insertion into the holes 50, 50a in pipe 27 that are used for the pivot of latch 41. The sleeve 51 preferably extends through pipe 27 such that the interior of sleeve 27 is not in contact with any of the surfaces of pipe 27, particularly the edges of openings 50, 50a. Openings 50, 50a should be sized (reduced or enlarged) in order to snugly receive sleeve 51. Once sleeve 51 has been inserted into openings 50, 50a of pipe 27, a bolt 55 is inserted through pivot openings 54, 54a in sides 42, 42a of latch 41, and through sleeve 51 as shown in FIG. 5. Accordingly, threaded surfaces of bolt 55 are shielded from pipe 27 by sleeve 51, while still allowing nut-bolt 55-56 to serve as a pivot for movement of latch 41. In these embodiments, a nut 56 is engaged to one end of bolt 55 to hold it in place. In other embodiments, one or more bushings may be provided between bolt 55 and the openings 50, 50a in pipe 27. In other embodiments, one or more similar shielding pieces may be provided in openings 50, 50a to shield the threads of bolt 55 from being stripped by frictional movement against these openings, allowing bolt 55 to be more easily removed when the time comes to remove and replace the latch. It is to be appreciated that one or more washers may also be provided with nut 56 and or bolt 55 to help hold them in place.

In accordance with the above, embodiments of latches of the present invention may be easily and quickly installed and removed from a support pipe without requiring the removal of other latches from the support pipe. Embodiments of the present invention also minimize stripping or other damage to the bolts that act as the pivotal mounts for holding stanchion latches of the present invention to the support pipe.

It is to be understood that variations and modifications of the present invention may be made without departing from the scope thereof. It is to be appreciated that different versions of the invention may be made from different combinations of the various features described above. It is also to be understood that the present invention is not to be limited by the specific embodiments disclosed herein, but only in accordance with the appended claims when read in light of the foregoing specification.

What is claimed is:

1. A latch assembly for use in a livestock stanchion comprising:
a. a one-piece body having two parallel side pieces defining a space between them, and a cross member extending between and joining said side pieces at upper ends thereof;
b. a first hole on one of said side pieces at a lower end thereof;
c. a second hole on the other of said side pieces at a lower end thereof generally across from said first hole;
d. a removable cross piece provided between said first and second holes spanning said space;
e. attachment members for attaching said cross piece to said first and second holes.

2. The latching assembly of claim 1 wherein said attachment member is selected from the group consisting of: a coupler and a pair of nuts; a nut and bolt; a rod and cotter pin; a pin with retainer clips; and a spring loaded pin assembly.

3. The latching assembly of claim 1 wherein each side piece further comprises a second hole at a lower pivot point for receiving a pivotable mounting assembly.

4. The latch of claim 3 further comprising a sleeve extending between said second pivot point holes for protecting the pivotable mounting assembly.

5. The latch of claim 4 wherein said sleeve comprises a spring pin.

6. The latch of claim 5 wherein said pivotable mounting assembly comprises a nut and corresponding bolt.

7. An improved latch for use with a livestock stanchion comprising a body having first and second parallel sides separated from and connected to each other by at least one connecting member, each side having an upper end, a lower pivot point and a lower leg portion, said connecting member being located near the upper ends of each side such that a space is defined between the sides that is open between the lower leg portions; and a removable cross member provided in said space between said lower leg portions of said first and second sides.

8. The latch of claim 7 wherein each side further comprises a hole in its lower leg portion for attaching said cross member to said side.

9. The latch of claim 8 further comprising a reinforced area around each of said holes.

10. The latch of claim 8 wherein said cross member has openings at opposite ends thereof, and is held in place between said lower leg portions by a pair of bolts inserted through said holes into said opposite end openings.

11. The latch of claim 8 wherein said cross member is a coupler nut having a helical bore at each end thereof for receiving a bolt such that said coupler nut is held in place between said lower leg portions by bolts inserted through said holes into said helical bores.

12. The latch of claim 8 wherein said cross member is a pin with retainer clips on opposite ends thereof for engagement with said holes in said lower leg portions.

13. The latch of claim 8 wherein said cross member is a cylindrical body with spring-loaded pins at opposite ends thereof for engagement with said holes in said lower leg portions.

14. The latch of claim 7 wherein each side further comprises a hole at its lower pivot point for receiving a pivotable mounting assembly.

15. The latch of claim 14 further comprising a sleeve extending between said lower pivot point holes for protecting the pivotable mounting assembly.

16. The latch of claim 15 wherein said sleeve comprises a spring pin.

17. The latch of claim 15 wherein said pivotable mounting assembly comprises a nut and corresponding bolt.

18. A method for installing a latch on a livestock stanchion assembly comprising the steps of:
a. straddling a pair of oppositely positioned parallel legs of a latch assembly over a generally horizontal support bar of said stanchion assembly, wherein the legs of said latch are connected at upper ends thereof, and wherein each leg has a first hole therein at a lower end thereof, and a second hole therein at a pivot point;
b. attaching a cross member to each of said legs between said first holes therein, said cross member extending underneath said support bar;
c. pivotally attaching said legs to said support bar using said second holes.

19. The method of claim 18 wherein said support bar has a pair of oppositely positioned holes therein at a pivot point, and comprising further the step of inserting a protective sleeve into and between said holes prior to pivotally attaching said legs to said support bar.

20. The method of claim 19 comprising the further step of changing the size of said oppositely positioned holes in said support bar to accommodate said sleeve prior to the insertion thereof.
